(19) United States
(12) Patent Application Publication
(10) Pub. No.: US 2017/0111572 A1
(43) Pub. Date: Apr. 20, 2017

(54) PROCESSING APPARATUS, PROCESSING SYSTEM, IMAGE PICKUP APPARATUS, PROCESSING METHOD, AND NON-TRANSITORY COMPUTER-READABLE STORAGE MEDIUM

(71) Applicant: CANON KABUSHIKI KAISHA, Tokyo (JP)

(72) Inventors: Yuichi Kusumi, Utsunomiya-shi (JP); Chiaki Inoue, Utsunomiya-shi (JP); Yoshiaki Ida, Utsunomiya-shi (JP)

(21) Appl. No.: 15/288,076

(22) Filed: Oct. 7, 2016

(30) Foreign Application Priority Data
Oct. 14, 2015 (JP) 2015-203056

(51) Int. Cl. H04N 5/232; H04N 5/357; H04N 13/02; H04N 5/378; H04N 5/225; H04N 5/235

(52) U.S. Cl. CPC H04N 5/23222; H04N 5/2256; H04N 5/2351; H04N 5/2354; H04N 13/0225; H04N 13/0282; H04N 5/378; H04N 5/357; H04N 13/0296; H04N 5/23212

(57) ABSTRACT

A processing apparatus determines a light source condition corresponding to an object distance, and performs control to image an object, which is sequentially irradiated with light from three or more light sources each different in a position on the basis of the light source condition.

### BACKGROUND OF THE INVENTION

Field of the Invention

The present invention relates to a processing apparatus, a processing system, an image pickup apparatus, a processing method, and a non-transitory computer-readable storage medium.

Description of the Related Art

Obtaining more physical information regarding an object can generate images based on a physical model in image processing after imaging. For example, an image where visibility of the object is changed can be generated. Visibility of the object is determined on the basis of information such as shape information of the object, reflectance information of the object and light source information. As physical behavior of reflected light that is emitted from a light source and is reflected by the object depends on a local surface normal, using not three-dimensional information but the surface normal of the object as shape information is especially effective. As a method obtaining the surface normal of the object, for example, a method that converts a three-dimensional shape calculated from distance information obtained using a method such as triangulation using laser light and a twin-lens stereo into surface normal information is known. However, such a method complicates the structure of the apparatus, and accuracy of the obtained surface normal is insufficient.

In Japanese Patent Laid-Open No.2010-122158 and “Photometric stereo” (A research report of Information Processing Society of Japan, Vol.2011-CVIM-177, No.29, pp.1-12, 2011) by Yasuyuki Matsushita, a photometric stereo method is disclosed as a method obtaining the surface normal of the object directly. The photometric stereo method is a method assuming reflectance characteristics of the object based on the surface normal of the object and a direction from the object to the light source and calculating the surface normal from luminance information of the object at a plurality of light source positions and the assumed reflectance characteristics. The reflectance characteristics of the object can be, for example, approximated using a Lambert reflection model in dependence upon a Lambert's cosine law.

In an image pickup apparatus such as a digital camera, when the surface normal is obtained using the photometric stereo method, the object need to be irradiated with light from a plurality of light sources, each of which is arranged at different positions. When the position of the light source is fixed, an angle (hereinafter referred to as “irradiation angle”) between an optical axis of an image pickup optical system included in the image pickup apparatus and light from the light source to the object decreases at greater distances from the object. In the photometric stereo method determining the surface normal of the object from luminance variations among a plurality of light source positions, when the irradiation angle lowers, the luminance variations decrease and influence of noise in the image pickup apparatus strengthens. As a result, variation in the calculated surface normal occurs.

### SUMMARY OF THE INVENTION

In the view of the problem, the present invention can provide a processing apparatus, a processing system, an image pickup apparatus, a processing method, and a non-transitory computer-readable storage medium capable of calculating a surface normal of an object accurately.

A processing apparatus according to one aspect of the present invention determines a light source condition corresponding to an object distance, and performs control to image an object, which is sequentially irradiated with light from three or more light sources each different in a position on the basis of the light source condition.

A processing system according to another aspect of the present invention includes a processing apparatus that determines a light source condition corresponding to an object distance, and performs control to image an object, which is sequentially irradiated with light from three or more light sources each different in a position on the basis of the light source position, and a calculator that calculates a surface normal of the object on the basis of variations among pieces of luminance information corresponding to each position of the light source.

An image pickup apparatus according to another aspect of the present invention includes an image pickup unit that includes an image pickup optical system, a plurality of light source groups each of which includes at least three light sources and has a different distance from an optical axis of the image pickup optical system, and an image pickup controller that determines a light source group irradiating the object with light on the basis of an object distance.

A processing method according to another aspect of the present invention includes a step of determining a light source condition corresponding to an object distance, and a step of performing control to image an object sequentially irradiated with light from three or more light sources, which are mutually different in a position, on the basis of the light source condition.

Further features of the present invention will become apparent from the following description of exemplary embodiments with reference to the attached drawings.

### BRIEF DESCRIPTION OF THE DRAWINGS

FIG. 1 is an appearance view of an image pickup apparatus according to a first example.

FIG. 2A is a block diagram of the image pickup apparatus according to the first example.

FIG. 2B is a block diagram of a processing apparatus.

FIG. 3 is a flowchart illustrating surface normal calculation processing according to the first example.

FIG. 4 is a relational diagram between receivers of an image pickup element and a pupil of an image pickup optical system.

FIG. 5 is a schematic diagram illustrating an image pickup system.

FIG. 6 is a schematic diagram illustrating other example of imaging.

FIG. 7 is a flowchart illustrating surface normal calculation processing according to a second example.

FIG. 8 is an appearance view illustrating a normal information obtaining system according to a third example.

FIG. 9 is an explanatory diagram of a Torrance-Sparrow model.

### DESCRIPTION OF THE PREFERRED EMBODIMENTS

Exemplary embodiments of the present invention will be described below with reference to the accompanied drawings. In each of the drawings, the same elements will be denoted by the same reference numerals and the duplicate descriptions thereof will be omitted.

The photometric stereo method is a method assuming reflectance characteristics of an object based on a surface normal of the object and a direction from the object to a light source and calculating the surface normal from luminance information of the object at a plurality of light source positions and the assumed reflectance characteristics. When the reflectance is not uniquely determined by receiving a predetermined surface normal and the light source position, the reflectance characteristics should be approximated using a Lambert reflection model in dependence upon a Lambert's cosine law. In addition, a specular reflection component, as illustrated in FIG. 9, depends on an angle α formed by a bisector of an angle between a light source vector s and a visual line direction vector v, and the surface normal n. Accordingly, the reflectance characteristics may be based on the visual line direction. Additionally, from the luminance information, influence by light such as environmental light other than light from the light source may be excluded by taking a difference between luminance of the object imaged in the case where the light source is lighted and luminance of the object imaged in the case where the light source is turned off.

Hereinafter, the reflectance characteristics assumed by the Lambert reflection model will be explained. When a luminance value of reflected light is i, Lambert diffuse reflectance of the object is ρ_{d}, intensity of incident light is E, a unit vector (a light source vector) representing a direction (light source direction) from the object to the light source is s, and a unit surface normal vector of the object is n, the luminance value i is expressed by the following expression (1) on the basis of the Lambert's cosine law.

i=Eρ_{d}s·n (1)

When components of different M (M≧3) light source vectors are respectively defined as s₁, s₂, . . . , s_{M} and luminance values for each component of the light source vectors are respectively defined as i₁, i₂, . . . , i_{M}, the expression (1) is expressed by the following expression (2).

$$[ \begin{matrix}{i}_{1} \\ ⋮ \\ {i}_{M}\end{matrix} ] = [ \begin{matrix}{s}_{1}^{T} \\ ⋮ \\ {s}_{M}^{T}\end{matrix} ] E {ρ}_{d} n \qquad ( 2 )$$

In the expression (2), the left side is a luminance vector expressed by a matrix of M row and 1 column, and a matrix [s₁^{T}, . . . , s_{M}^{T}] and a symbol n of the right side are respectively an incident light matrix S of M row and 3 column representing the light source direction, and the unit surface normal vector expressed by a matrix of 3 row and 1 column. When the number M is equal to 3, a product Eβ_{d}n are expressed by the following expression (3) using an inverse matrix S⁻¹ of the incident light matrix S.

$$E {ρ}_{d} n = {S}^{- 1} [ \begin{matrix}{i}_{1} \\ ⋮ \\ {i}_{M}\end{matrix} ] \qquad ( 3 )$$

A norm of vectors of the left side of the expression (3) is a product of the intensity E of the incident light and the Lambert diffuse reflectance ρ_{d}, and a normalized vector is calculated as a surface normal vector of the object. In other words, the intensity E of the incident light and the Lambert diffuse reflectance ρ_{d} is expressed as the product in the expression. When the product Eρ_{d} is considered as one variable, the expression (3) is regarded as simultaneous equations to determine unknown three variables with two freedom degrees of the unit surface normal vector n. Thus, obtaining the luminance information using at least three light source can determine each variable. When the incident light matrix S is not a regular matrix, an inverse matrix of the incident light matrix S does not exist and thus the components s₁ to s₃ of the incident light matrix S should be selected so that the incident light matrix S is the regular matrix. That is, the component s₃ is preferably selected linearly independently with respect to the components s₁ and s₂.

Additionally, when the number M is larger than 3, conditions more than unknown variables are obtained and thus the unit surface normal vector n may be calculated from arbitrary selected three conditional expressions using the same method as the method in the case where the number M is equal to 3. When four or more conditional expressions are used, the incident light matrix S is not the regular matrix. In this case, for example, an approximate solution may be calculated using a Moore-Penrose pseudo inverse matrix. The unit surface normal vector n may be also calculated using a fitting method or an optimization method.

When the reflectance characteristics are assumed by a model different from the Lambert reflection model, the conditional expression may differ from a linear equation for each component of the unit surface normal vector n. In this case, if the conditional expressions more than unknown variables are obtained, the fitting method or the optimization method can be used.

Moreover, when the number M is larger than 3, a plurality of conditions between 3 and M-1 are obtained and thus a plurality of solution candidates of the unit surface normal vector n can be calculated. In this case, a solution should be selected from the plurality of solution candidates using further another condition. For example, continuity of the unit surface normal n can be used as the condition. In calculating the unit surface normal n for each of pixels of the image pickup apparatus, when the surface normal in a pixel (x, y) is n (x, y) and a pixel n (x−1, y) is known, a solution may be selected to minimize an evaluation function expressed by the following expression (4).

1−n(x, y)·n(x−1, y) (4)

Furthermore, when pixels n (x+1, y) and n (x, y±1) are known, a solution may be selected to minimize the following expression (5).

4−n(x, y)·n(x−1, y)−n(x, y)·n(x+1, y)−n(x, y)·n(x, y−1)−n(x, y)·n(x, y+1) (5)

When a known surface normal does not exist and indefiniteness of the surface normal at each of all pixel positions exists, a solution may be selected to minimize a sum of all pixels of the expression (5) expressed by the following expression (6).

$${\sum }_{x , y} \{ 4 - n ( x , y ) \cdot n ( x - 1 , y ) - n ( x , y ) \cdot n ( x + 1 , y ) - n ( x , y ) \cdot n ( x , y - 1 ) - n ( x , y ) \cdot n ( x , y + 1 ) \} \qquad ( 6 )$$

A surface normal in a pixel other than a nearest pixel or an evaluation function weighted according to a distance from a target pixel position may be also used.

In addition, as another condition, luminance information at an arbitrary light source position may be used. In a diffuse reflection model represented by the Lambert reflection model, luminance of reflected light increases with an approach of the unit normal vector and the light source direction vector. Accordingly, selecting a solution close to the light source direction vector having the largest luminance value of luminance values at a plurality of light source directions can determines the unit surface normal vector.

Alternatively, in a specular reflection model, when the light source vector is s and a unit vector (a visual line vector of a camera) of a direction from the object to the camera, the following expression (7) is satisfied.

s+v=2(v·n)n (7)

As expressed by the expression (7), when the light source vector s and the visual line vector of the camera v are known, the unit surface normal vector n can be calculated. When a surface has roughness, specular reflection has a spread of an emitting angle, but spreads near a solution calculated by assuming that the surface is smooth. Thus, a candidate near the solution with respect to the smooth surface from the plurality of solution candidates may be selected.

Besides, a true solution may be determined using an average of the plurality of solution candidates.

### FIRST EXAMPLE

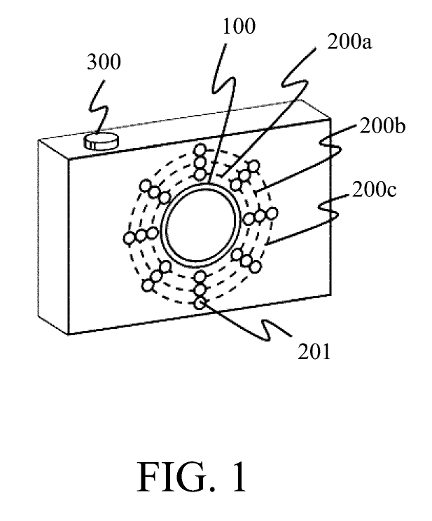

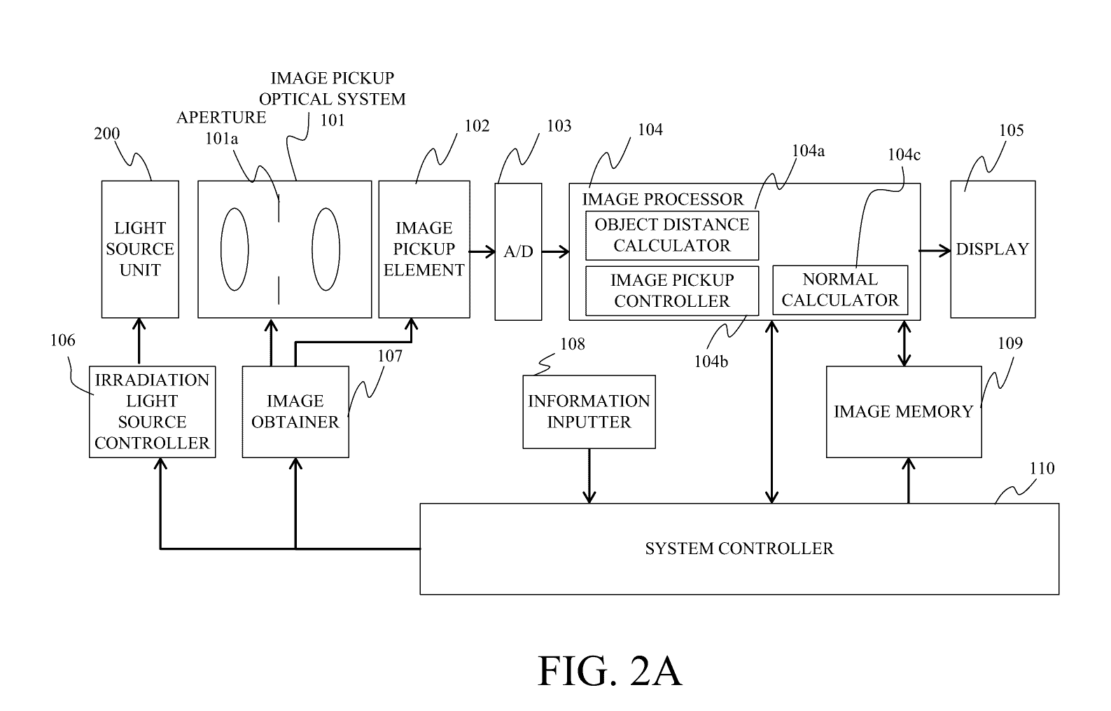

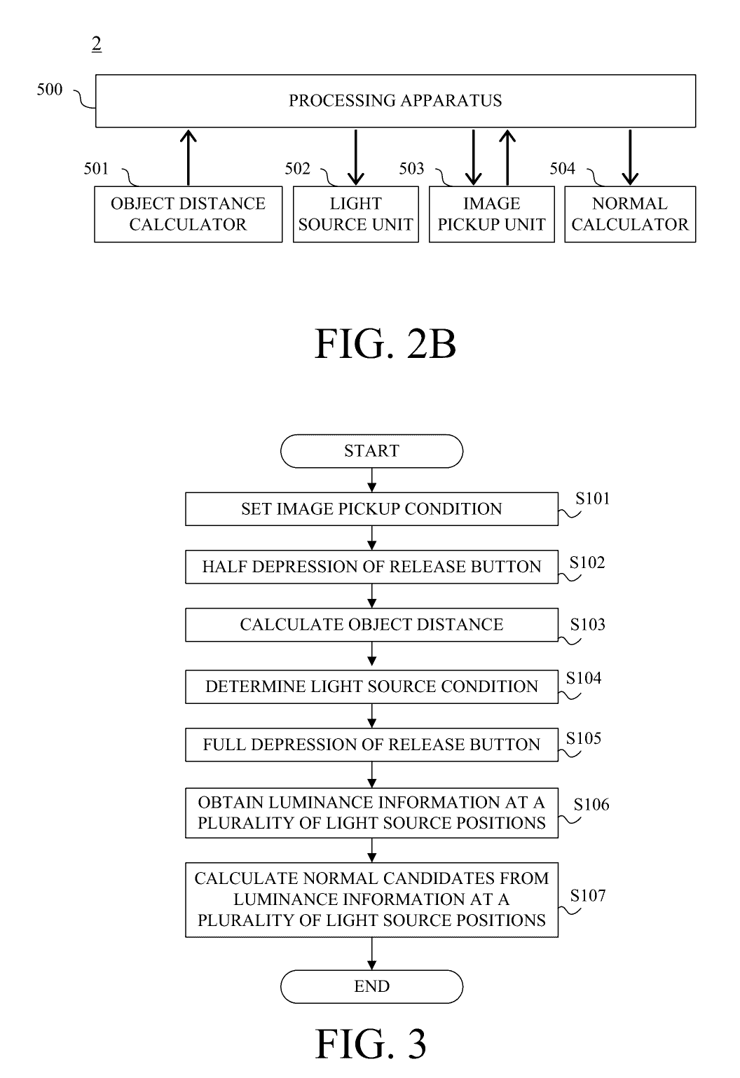

FIG. 1 is an appearance view of an image pickup apparatus 1 according to this example, and FIG. 2A is a block diagram of the image pickup apparatus 1. The image pickup apparatus 1 includes an image pickup unit 100, a light source unit 200 and a release button 300. The image pickup unit 100 includes an image pickup optical system 101. The light source unit 200 includes three light source groups 200a, 200b and 200c each having a different distance from an optical axis of the image pickup optical system 101. Each light source group includes eight light sources 201 arranged at equal intervals in a concentric circle shape around the optical axis of the image pickup optical system 101. As light sources necessary to perform the photometric stereo method are three, each light source group may include three or more light sources. In this example, the light source unit 200 includes three light source groups 200a, 200b and 200c and each light source group includes the plurality of light sources arranged at equal intervals in the concentric circle shape around the optical axis of the image pickup optical system 101, but the present invention is not limited to this. In this example, the light source unit 200 is also built in the image pickup apparatus 1, but may be detachably attached to the image pickup apparatus 1. The release button 300 is a button to perform photographing and automatic focus.

The image pickup optical system 101 includes an aperture 101a and forms an image of light from an object on the image pickup element 102. The image pickup element 102 is configured by a photoelectric conversion element such as a CCD sensor and a CMOS sensor, and images the object. An analog electrical signal generated by the photoelectric conversion of the image pickup element 102 is converted into a digital signal by an A/D convertor 103 and the digital signal is input to an image processor 104. The image processor 104 performs general image processing to the digital signal and calculates normal information of the object. The image processor 104 includes an object distance calculator 104a that calculates an object distance, an image pickup controller 104b that determines a light source condition based on the object distance, and a normal calculator 104c that calculates the normal information. An output image processed by the image processor 104 is stored in an image memory 109 such as a semiconductor memory and an optical disc. The output image may be also displayed by a display 105. In this embodiment, the object distance calculator 104a, the image pickup controller 104b and the normal calculator 104c are incorporated in the image pickup apparatus 1, but may be configured separately from the image pickup apparatus 1 as described below.

An information inputter 108 supplies a system controller 110 with image pickup conditions (for example, an aperture value, an exposure time and a focal length) selected by a user. An image obtainer 107 obtains images on the desired condition selected by the user on the basis of information from the system controller 110. An irradiation light source controller 106 controls a light emitting state of the light source unit 200 depending on instructions from the system controller 110. The image pickup optical system 101 may be built in the image pickup apparatus 1 and may be detachably attached to the image pickup apparatus 1 as a single-lens reflex camera.

FIG. 3 is a flowchart illustrating surface normal information calculation processing according to this example. The surface normal information calculation processing according to this example is executed by the system controller 110 and the image pickup controller 104b in accordance with a processing program as a computer program. The processing program may be stored in, for example, a storage medium readable by a computer.

At step S101, the information inputter 108 supplies the system controller 110 with the image pickup conditions selected by the user.

At step S102, it is determined whether or not the release button 300 is half depressed. When the release button 300 is half depressed, the image pickup apparatus 1 becomes an image pickup preparation state. And then autofocus and preliminary photographing needed at the following step are performed, and preliminary images are stored in a memory or a DRAM (dynamic RAM), which is not illustrated.

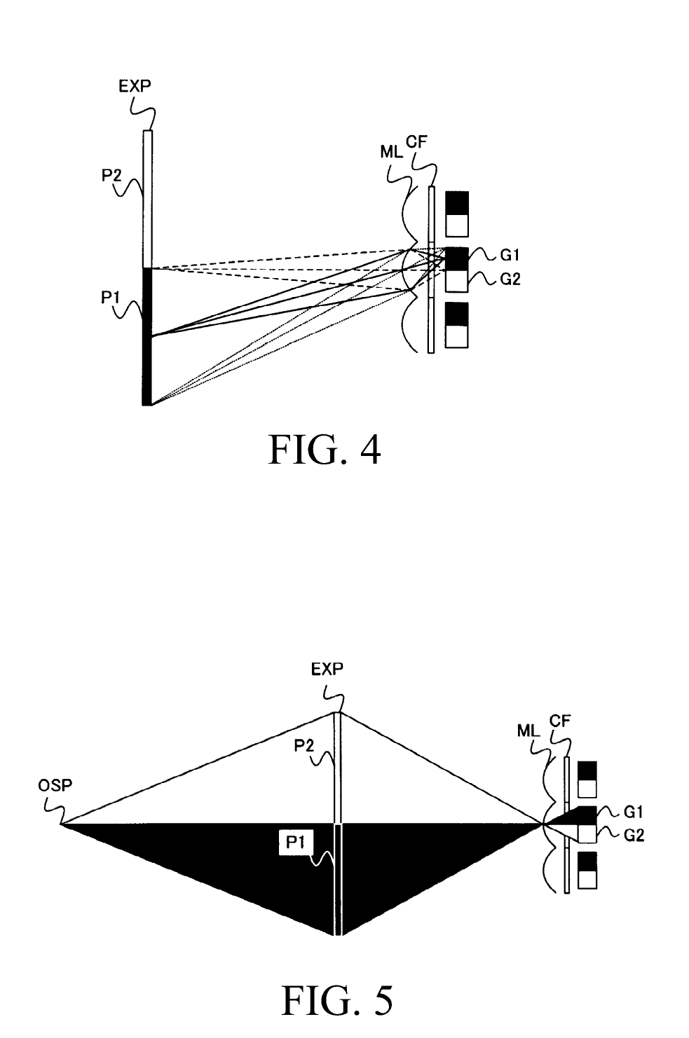

At step S103, the object distance calculator 104a calculates the object distance. In this example, the object distance is calculated from a position of a focus lens in performing the automatic focus at step S102 or manual focus by the user. The object distance may be also calculated by a stereo method obtaining a plurality of parallax images, which are photographed from different viewpoints. In the stereo method, a depth is calculated from a parallax quantity of a corresponding point of the object in the obtained plurality of parallax images, position information of each viewpoint in photographing, and a focus distance of an optical system by triangulation. The object distance may be an average of the depths calculated for each corresponding point of the object or a depth calculated using a specific corresponding point. When the object distance is calculated from the parallax images, an image pickup unit of the plurality of parallax images, as illustrated in FIG. 4, includes an image pickup unit that guides a plurality of light fluxes passing through different regions of a pupil of an image pickup optical system to different light receivers (pixels) of an image pickup element so as to photoelectrically convert them.

FIG. 4 is a relational diagram between receivers of an image pickup element and a pupil of an image pickup optical system. The image pickup element includes a plurality of pairs, each of which is a pair (a pixel pair) of G1 and G2 pixels being the receivers. A plurality of G1 pixels are collectively referred to as a G1 pixel group, and a plurality of G2 pixels are collectively referred to as a G2 pixel group. The pair of G1 and G2 pixels and an exit pupil EXP of the image pickup optical system has a conjugate relation through a common microlens ML (in other words, respectively provided for each pixel pair). Between the microlens ML and the receivers, a color filter CF is also provided.

FIG. 5 is a schematic diagram of an image pickup system on the assumption that a thin lens is arranged at a position of the exit pupil EXP. The G1 pixel receives a light flux passing through a P1 region of the exit pupil EXP, and the G2 pixel receives a light flux passing through a P2 region of the exit pupil EXP. An object is not necessarily existed at an imaging object point OSP, and a light flax passing through the object point OSP is incident on the G1 pixel or the G2 pixel according to a region (a position) in the passing pupil. Passing of the light flux through mutually different regions in the pupil corresponds to separating incident light from the object point OSP by an angle (a parallax). That is, images generated using each output signal from the G1 or G2 pixel of the G1 and G2 pixels provided for each microlens ML are the plurality of (here, a pair of) parallax images having mutually parallaxes. In the following descriptions, receiving a light flux, which passed through mutually different regions in a pupil, by mutually different receivers (pixels) is referred to as a pupil split.

In FIGS. 4 and 5, even if, due to a shift of the position of the exit pupil EXP, the above conjugate relation is incomplete or the P1 and P2 region are partially overlapped, the obtained plurality of images can be treated as parallax images.

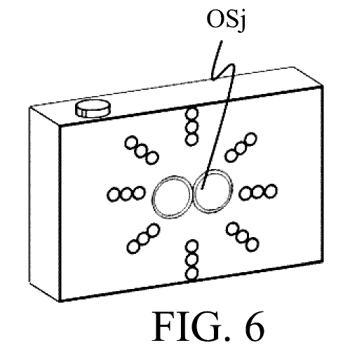

FIG. 6 is a schematic diagram illustrating other example of imaging. As illustrated in FIG. 6, one image pickup apparatus includes a plurality of image pickup optical systems OSj (j=1, 2) and thus can obtain parallax images. Imaging the same object using a plurality of cameras can also obtain the parallax images.

At step S104, the image pickup controller 104b determines a light source condition in performing the photometric stereo method on the basis of the object distance calculated at step S103. In this example, light source groups, each of which irradiates the object with light, are previously set for an object distance, and the light source group, which is used in performing the photometric stereo method, is determined on the basis of the calculated object distance. When the position of the light source is fixed, an angle (an irradiation angle) between the optical axis of the image pickup optical system and the light source direction decreases at greater distances from the object. In the photometric stereo method calculating the surface normal of the object from luminance variations among a plurality of light source positions, when the irradiation angle lowers, the luminance variations decrease and influence of noise strengthens. When the influence of noise strengthens, variation in the calculated surface normal occurs. Performing image processing, which changes visibility of the object using the varied surface normal, amplifies noise of the original image. Accordingly, the light source group, which satisfies the light source condition that the irradiation angle is larger than a threshold value (a first threshold value), is preferably selected. For example, the light source group is selected so that the irradiation angle θ is the following expression (8).

$$θ \geq \frac{1}{2} {cos}^{- 1} ( \frac{c \cdot {σ}_{n}}{E} ) \qquad ( 8 )$$

In the expression (8), σₙ is a standard deviation of the noise of the image pickup apparatus and c is a constant. The incident light intensity E is restricted by a dynamic range of the image pickup apparatus 1. In this example, the threshold value for the irradiation angle is provided by the expression (8), but the present invention is not limited to this. The threshold value for the irradiation angle may be provided by a condition different from the expression (8).

When the irradiation angle cannot be made larger than the threshold value by changing the light source position, the irradiation angle can be made larger than the threshold value by shortening the object distance. In this case, for the user, the display 105 may display to move (approach the object). Additionally, for the user, the display 105 may display an alert that an error occurs in the calculated surface normal.

Moreover, when the irradiation angle enlarges, a shade region in the object increases and thus calculations of the surface normal become difficult. Thus, a threshold value to limit the irradiation angle may be provided.

Further, on the basis of the calculated object distance, a guide number of the light source, which irradiates the object with light, may be determined. In the photometric stereo method, the surface normal is obtained on the assumption that the obtained luminance information is resulted from an only light source irradiating the object with light. Thus, when the object is irradiated with reflected light generated in the case where something other than the object is irradiated with light from the light source, an error occurs in the calculated surface normal. Accordingly, a widening angle of the light source is preferably adjusted to irradiate only the object or a photographing field angle range with light. That is, this corresponds to adjusting the guide number of the light source. Further, to irradiate the object with light from the light source, the optical axis (an irradiation direction) of the light source may be adjusted.

At step S105, it is determined whether or not the release button 300 is depressed fully. When the release button 300 is depressed fully, the image pickup apparatus 1 becomes a photographing state, and main photographing starts.

At step S106, the system controller 110 controls the irradiation light source controller 106 to sequentially irradiate the object with light from the light sources of the selected light source group, and causes the image pickup unit 100 to image the object through the image obtainer 107.

At step S107, the normal calculator 104b calculates the surface normal from variations among pieces of luminance information corresponding to each light source position using the photometric stereo method.

In this example, the surface normal of the object is calculated in the image pickup apparatus 1, but, as illustrated in FIG. 2B, may be calculated using a processing system 2 having a configuration different from that of the image pickup apparatus 1. The processing system 2 illustrated in FIG. 2B includes a processing apparatus 500, an object distance calculator 501, a light source unit 502, an image pickup unit 503 and a normal calculator 504. When the processing system 2 calculates the surface normal, first, the processing apparatus 500 determines a light source condition corresponding to an object distance calculated by the object distance calculator 501, and lights the light source unit 502 according to the determined light source condition. Subsequently, the processing apparatus 500 causes the image pickup unit 503 to image the object irradiated with light from the light source unit 502, and causes the normal calculator 504 to calculate the normal information using the image imaged by the image pickup unit 503. The processing system may include at least the processing apparatus 500 and the normal calculator 504, and the processing apparatus 500 may include the normal calculator 504. Moreover, the object distance calculator 501 and the light source unit 502 may be individual apparatuses, and may be built in the image pickup unit 503.

As mentioned above, in this example, the surface normal of the object can be calculated under the suitable light source condition based on the object distance.

### SECOND EXAMPLE

In this example, a surface normal is calculated using the same image pickup apparatus as the first example. In this example, when an object has many shade regions in irradiating with light from a light source, the surface normal is calculated under a suitable light source condition by performing rephotographing where a light source condition is changed.

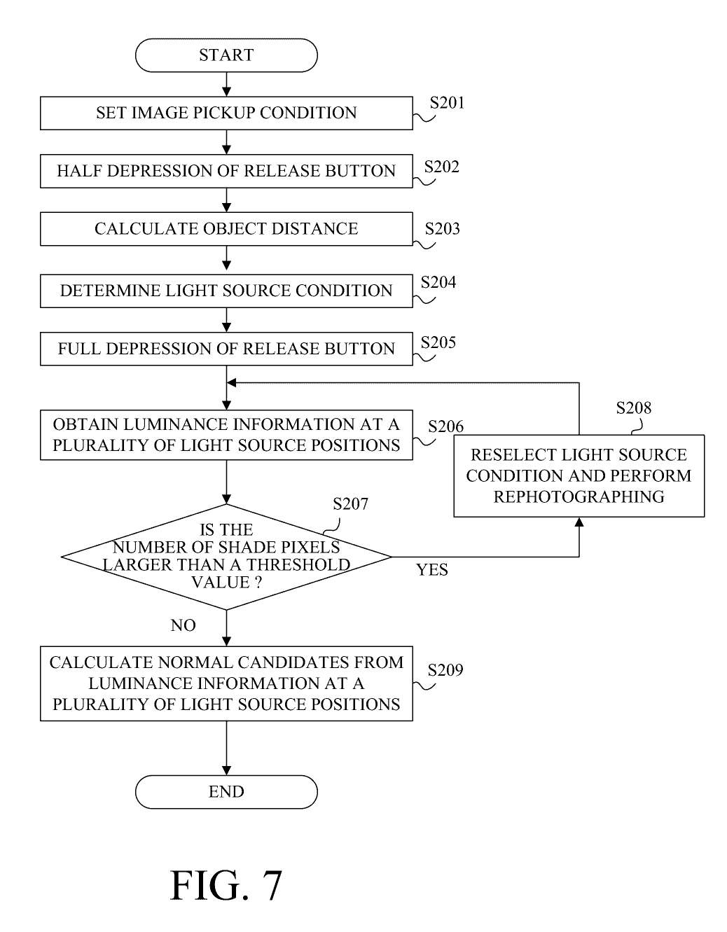

FIG. 7 is a flowchart illustrating surface normal information calculation processing according to this example. The surface normal information calculation processing according to this example is executed by the system controller 110 and the image pickup controller 104b in accordance with a processing program as a computer program.

As step S201 to S206 and S209 are respectively the same as step S101 to S107 according to the first example, detail explanations thereof are omitted.

At step S207, the image pickup controller 104b calculates the number of shade pixels, each of which is a shade region of the object, that is, has a luminance value smaller than a predetermined value, and determines whether or not the calculated number is larger than a threshold value (a second threshold value). In accordance with increasing of an irradiation angle, the shade region of the object widens and calculation of the surface normal becomes difficult. Especially, when the object distance is short, the irradiation angle increases and the shade region widens. The shade region of the object changes according to the shape of the object. Accordingly, when the number of the shade pixels increases, a light source group which decreases the irradiation angle is preferably selected. In this example, the shade pixel is a region including at least one pixel, which has a luminance value smaller than the predetermined value, in pixels of each of the plurality of images imaged at the plurality of light source positions. Furthermore, in the photometric stereo method, as at least three pieces of luminance information are required, the shade pixel may be a region including two or less pixels, each of which has a luminance value larger than the threshold value, in pixels of the plurality of images. If the detected number of the shade pixels is larger than the threshold value (the second threshold vale), advances the flow to step S208, and otherwise advances the flow to step S209. Advancing the flow to either step S208 or step S209 may be determined on the basis of a rate of the shade region of the object to all region of the object.

At step S208, a light source group, which has an irradiation angle smaller than that of the light source group set at step S204, is reselected, and rephotographing is performed. For example, when the light source group 200b is selected at step S204, the light source group 200a, which has an irradiation angle smaller than that of the light source group 200b, is reselected to perform rephotographing. However, the irradiation angle of the reselected light source group should be prevented from being smaller than the threshold value set at step S204. When a reduction quantity of the number of the shade pixels before or after rephotographing is smaller than a threshold value or the light source group capable of reducing the irradiation angle is not existed, the flow may be shifted to step S209 without performing rephotographing.

As mentioned above, in this example, the surface normal of the object can be calculated under the suitable light source condition based on the object distance. Especially, in this example, when the shade region is expanded in the object, performing rephotographing after redetermining the suitable light source condition based on the object distance can obtain the surface normal of the object under the more suitable light source condition.

### THIRD EXAMPLE

In the first and second examples, the image pickup apparatus including the light source was explained, but, in this example, a normal information obtaining system including an image pickup apparatus and a light source unit will be explained.

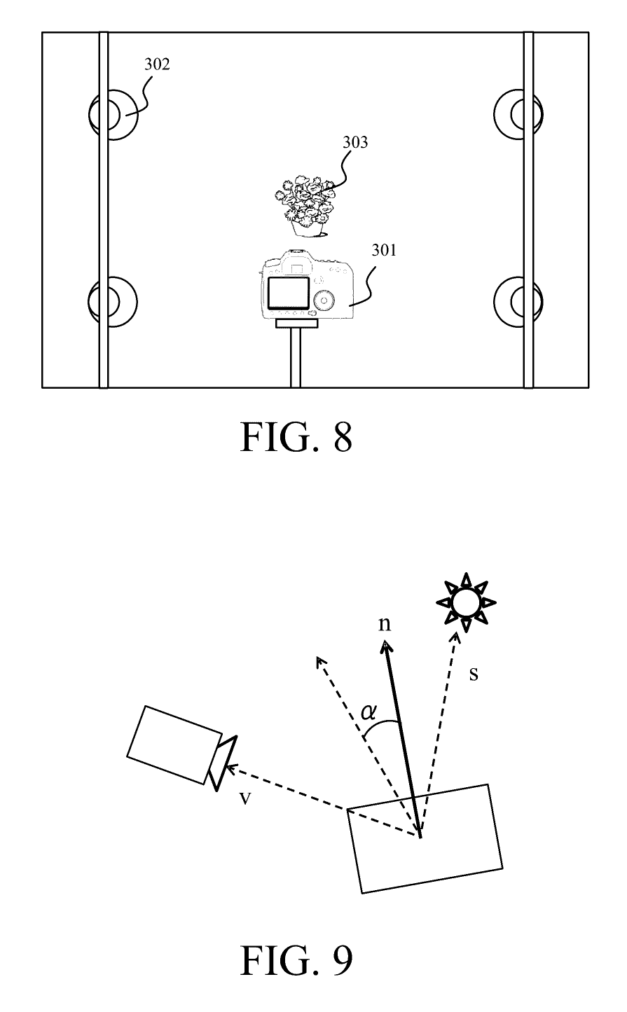

FIG. 8 is an appearance view illustrating the normal information obtaining system. The normal information obtaining system includes an image pickup apparatus 301 imaging an object 303, and a plurality of light source units 302. The image pickup apparatus 301 according to this example is the same as that according to the first embodiment, but need not include the plurality of light sources for the photometric stereo method as a light source unit. The light source unit 302 is connected with the image pickup apparatus 301 by wire or wireless and is preferably controlled on the basis of information from the image pickup apparatus 301. The light source unit 302 also preferably includes a mechanism that can automatically change a light source position on the basis of a light source condition determined using an object distance from the image pickup apparatus 301 to the object. When the light source unit 302 cannot automatically change the light source position or cannot be controlled by the image pickup apparatus 301, users may adjust the light source unit 302 to satisfy the light source condition displayed by a display of the image pickup apparatus 301.

As with the first example, the image pickup apparatus 301 may include a plurality of light source unit groups each of which has a different distance from an optical axis of an image pickup optical system, and each light source unit group may include a plurality of light sources.

In the photometric stereo method, images imaged using at least three light sources are required, but, when a light source unit which can change the light source position is used like this example, the light source unit may include at least one light source. However, changing positions of the light source unit to perform photographing at least three light source positions is required.

As mentioned above, in this example, the surface normal of the object can be calculated under the suitable light source condition based on the object distance. Surface normal calculation processing according to this example is the same as the processing of the first or second example, detailed explanations thereof are omitted.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2015-203056, filed on Oct. 14, 2015, which is hereby incorporated by reference herein in its entirety.

What is claimed is:

1. A processing apparatus, wherein the processing apparatus determines a light source condition corresponding to an object distance, and performs control to image an object, which is sequentially irradiated with light from three or more light sources each different in a position on the basis of the light source condition.

2. The processing apparatus according to claim 1, wherein the light source condition includes at least information on a position of the light source.

3. The processing apparatus according to claim 1, further comprising a calculator that calculates a surface normal of the object on the basis of variations among pieces of luminance information corresponding to a position of the light source.

4. The processing apparatus according to claim 1,
wherein the object is imaged through an image pickup optical system, and
wherein the processing apparatus determines a position of the light source so that a distance between the light source and an optical axis of the image pickup optical system increases as the object distance increases.

5. The processing apparatus according to claim 4, wherein the processing apparatus determines the position of the light source so that an angle between the optical axis and a line connecting the object and the light source is larger than a first threshold value.

6. The processing apparatus according to claim 5, wherein the processing apparatus alert users when the angle larger than the first threshold is unable to be set.

7. The processing apparatus according to claim 5, wherein the processing apparatus encourages users to move the image pickup optical system when the angle larger the first threshold is unable to be set.

8. The processing apparatus according to claim 1, wherein, when, in a plurality of images obtained by imaging the object, the number of shade pixels, each of which has a luminance value smaller than a predetermined value, is larger than a second threshold, the processing apparatus redetermines a position of the light source so that the number of shade pixels decreases.

9. A processing system comprising:
a processing apparatus that determines a light source condition corresponding to an object distance, and performs control to image an object, which is sequentially irradiated with light from three or more light sources each different in a position on the basis of the light source position; and
a calculator that calculates a surface normal of the object on the basis of variations among pieces of luminance information corresponding to a position of the light source.

10. The processing system according to claim 9, further comprising a light source unit that includes three or more light sources each different in a position.

11. An image pickup apparatus comprising:
an image pickup unit that includes an image pickup optical system;
a plurality of light source groups each of which includes at least three light sources and has a different distance from an optical axis of the image pickup optical system; and
an image pickup controller that determines a light source group irradiating the object with light on the basis of an object distance.

12. The image pickup apparatus according to claim 11, wherein the image pickup controller changes a guide number of the light source irradiating the object with light on the basis of the object distance and an angle of view.

13. The image pickup apparatus according to claim 11, further comprising a distance calculator that calculates the object distance.

14. The image pickup apparatus according to claim 13, wherein the distance calculator calculates the object distance on the basis of a position of a focus lens of the image pickup optical system.

15. The image pickup apparatus according to claim 13,
wherein the image pickup unit obtains parallax images having parallaxes mutually, and
wherein the distance calculator calculates the object distance from the parallax images.

16. The image pickup apparatus according to claim 15, wherein the image pickup unit includes an image pickup element that photoelectrically converts a plurality of light fluxes guided to different pixels after passing through different regions of a pupil of the image pickup optical system.

17. The image pickup apparatus according to claim 15, wherein the image pickup unit includes an image pickup unit that has a plurality of pixel pairs to photoelectrically convert light flux from different regions of a pupil of the image pickup optical system, and a microlens provided for each of the pixel pairs.

18. A processing method comprising:
a step of determining a light source condition corresponding to an object distance; and
a step of performing control to image an object, which is sequentially irradiated with light from three or more light sources each different in a position on the basis of the light source condition.

19. A non-transitory computer-readable storage medium configured to store a computer program that enables a computer to execute a processing method,
wherein the processing method includes:
a step of determining a light source condition corresponding to an object distance; and
a step of performing control to image an object, which is sequentially irradiated with light from three or more light sources each different in a position on the basis of the light source condition.
